(19) United States
(12) Patent Application Publication
(10) Pub. No.: US 2026/0014057 A1
(43) Pub. Date: Jan. 15, 2026

(54) QUICK-FILL PILL ORGANIZER

(71) Applicant: E-LINK PLASTIC & METAL INDUSTRIAL CO., LTD., NEW TAIPEI CITY (TW)

(72) Inventor: YU CHIN HSU, NEW TAIPEI CITY (TW)

(21) Appl. No.: 18/767,548

(22) Filed: Jul. 9, 2024

(51) Int. Cl. A61J 1/03; A61J 7/00; B65D 25/04; B65D 43/16; B65D 43/22

(52) U.S. Cl. CPC A61J 1/03; A61J 7/0084; B65D 25/04; B65D 43/164; B65D 43/22; B65D 2543/00842

(57) ABSTRACT

A quick-fill pill organizer has a box, multiple retrieving covers, and a packaging cover. The box has multiple compartments. Each compartment has a retrieving opening and a packaging opening. The retrieving cover is mounted on the retrieving opening and corresponds to the compartment one-to-one such that the corresponding compartment connects to or is blocked from the outside. The packaging cover is mounted on the packaging openings such that all the compartments connect to or are blocked from the outside at the same time. When the retrieving openings are upward, the retrieving cover of the specific compartment can be opened. When the packaging openings are upward, the packaging cover can be opened or closed such that all of the compartments connect to or are blocked from outside at once.

### BACKGROUND OF THE INVENTION

### 1. Field of the Invention

The present invention relates to a pill organizer, especially to a pill organizer capable of distributing medicines.

### 2. Description of the Prior Arts

To allow the user to easily distribute the medicines that need to be taken at a time, or to reduce the weight of luggage when going out, there are a variety of repackaged pill organizers on the market, allowing the user to distribute medicines or health foods according to their own needs. The repackaged pill organizer comprises a plurality of compartments. Each compartment can hold a single dose of medication and has a corresponding lid for each compartment. When the user takes medicine, he/she only needs to open the lid of one compartment to prevent medicines in the other compartments from spilling or getting damp.

However, when the user is distributing the medicine, one compartment corresponds to one lid, which causes inconvenience to the user. Precisely, the process of dispensing medicines involves first opening the lids of all compartments, placing the medicines into the corresponding compartments one by one, and then closing the lids of all compartments. The multiple lids require the lids to be opened and closed one by one each time the medicine is dispensed. As a result, the user needs to spend a lot of time opening and closing the lids during the process of dispensing the medicine.

To overcome the shortcomings, the present invention provides a quick-fill pill organizer to mitigate or obviate the aforementioned problems.

### SUMMARY OF THE INVENTION

The main objective of the present invention is to provide a quick-fill pill organizer that can be in a retrieval mode and a package mode. The user can take the medicine in the retrieval mode and dispense the medicine in the package mode.

The quick-fill pill organizer has a box, multiple retrieving covers, and a packaging cover. The box has multiple compartments mounted next to each other. Each one of the compartments has a retrieving opening and a packaging opening. The retrieving opening and the packaging opening are opposite to each other in position. An amount of the retrieving covers corresponds to an amount of the compartments. Each one of the retrieving covers is mounted on the retrieving opening of a respective one of the compartments such that said respective one of the compartments selectively connects to or is blocked from outside respectively. The packaging cover is mounted on the packaging openings of the compartments such that all of the compartments selectively connect to or are blocked from outside.

The benefit of the present invention is that the compartment of the quick-fill pill organizer comprises the retrieving opening and the packaging opening. The retrieving cover mounted at the retrieving opening corresponds to the compartment one-to-one, and the packaging cover mounted at the packaging openings can cover all the compartments at the same time. When the user takes the medicine in the retrieval mode, he/she turns the retrieving openings upward and opens the retrieving cover corresponding to the specific compartment to prevent the medicine in the other compartments from spilling or getting damp. When the user distributes the medicine into each compartment in the package mode, the packaging openings are upward and the packaging cover is opened. The user only needs to open or close the packaging cover once to connect or close all the packaging openings of the compartments. Therefore, the user can save a lot of time opening and closing the cover during the process of dispensing medicine.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a quick-fill pill organizer in the storage mode;

FIG. 2 is a perspective view of the quick-fill pill organizer in FIG. 1, shown in the retrieval mode;

FIG. 3 is a perspective view of the quick-fill pill organizer in FIG. 1, shown in the package mode;

FIG. 4 is an exploded view of the quick-fill pill organizer viewed from a first angle in FIG. 1;

FIG. 5 is an exploded view of the quick-fill pill organizer viewed from a second angle in FIG. 1; and

FIG. 6 is an exploded view of the quick-fill pill organizer viewed from a third angle.

### DETAILED DESCRIPTION OF THE PREFERRED EMBODIMENTS

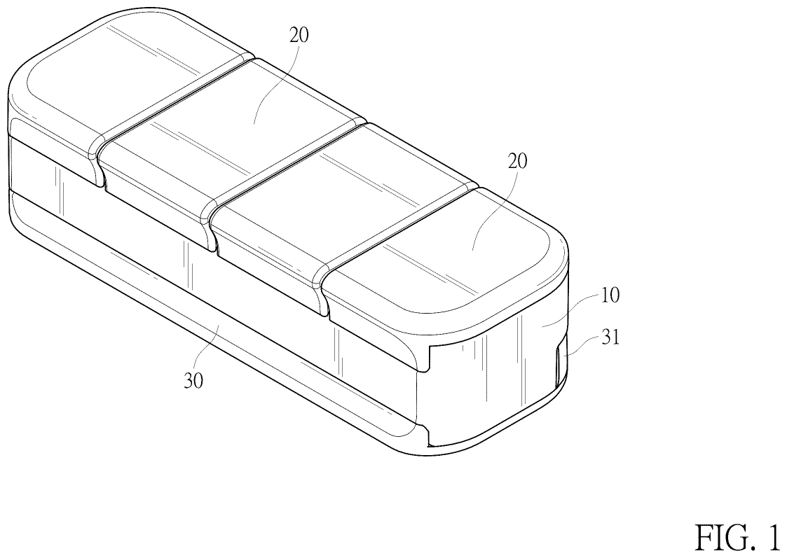

With reference to FIG. 1 to FIG. 3, a quick-fill pill organizer in accordance with the present invention is configured to dispense medicine or health food. The quick-fill pill organizer can be in a storage mode, a retrieval mode, and a package mode. The quick-fill pill organizer comprises a box 10, multiple retrieving covers 20 and a packaging cover 30.

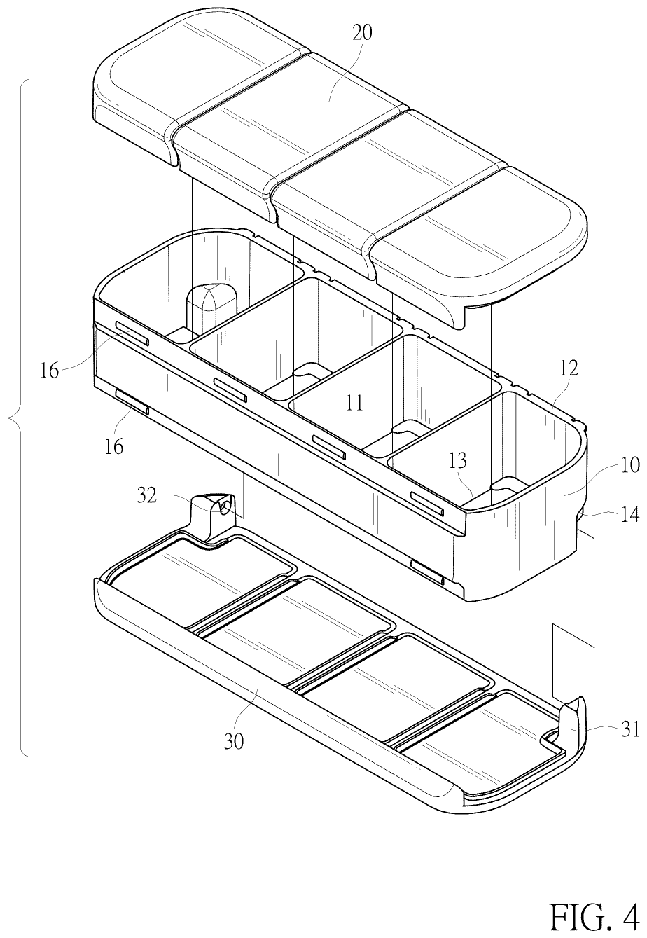

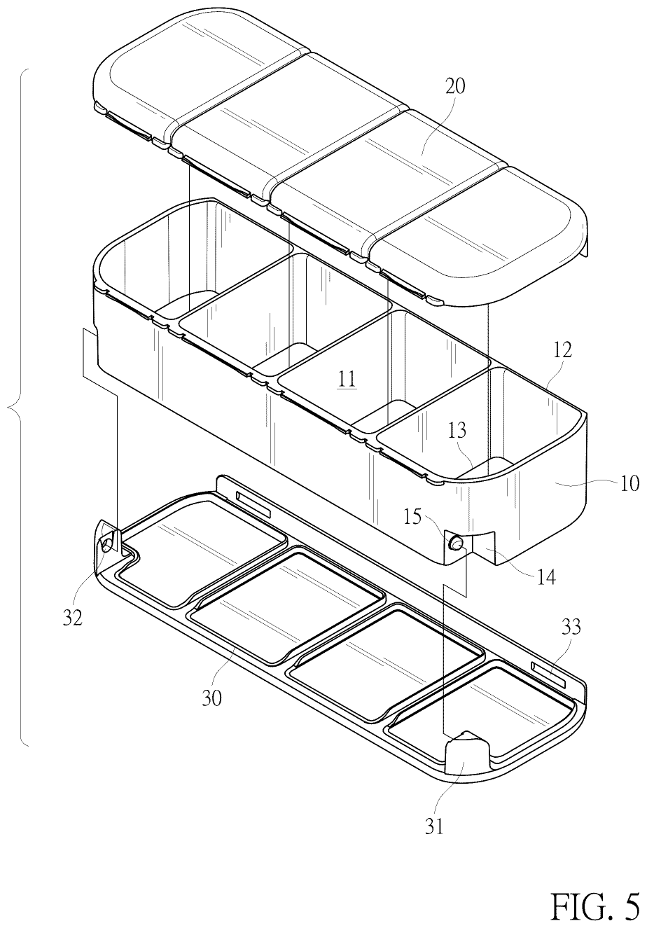

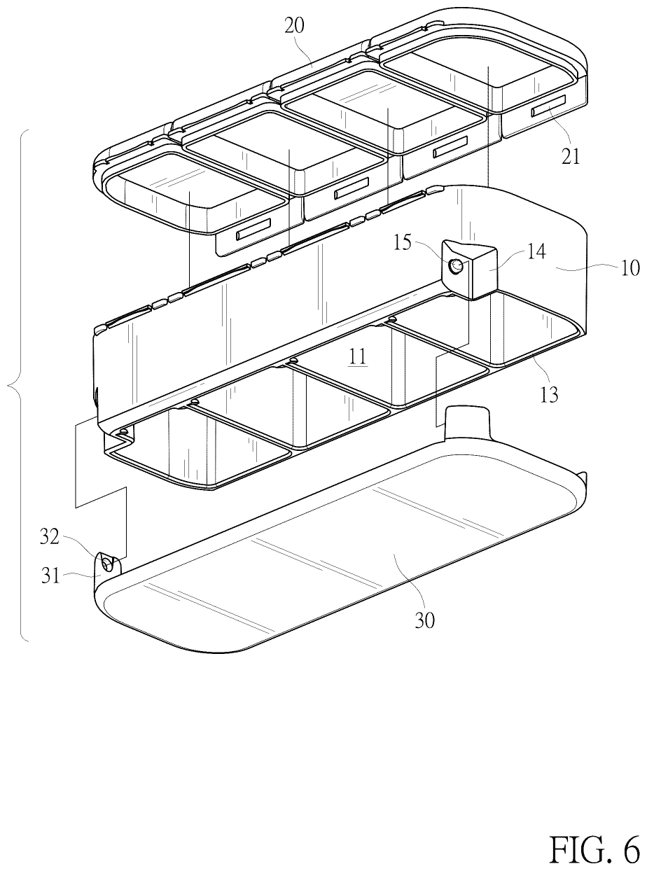

With reference to FIG. 4 to FIG. 6, the box 10 comprises multiple compartments 11, two concave structures 14, two engaged shafts 15, and multiple buckle units 16. The compartments 11 are mounted next to each other, and each one of the compartments 11 comprises a retrieving opening 12 and a packaging opening 13. The retrieving opening 12 and the packaging opening 13 are formed at two opposite ends of the compartment 11. In this embodiment, the box 10 has four compartments 11 in total, and the four compartments 11 are arranged in a straight line. In another embodiment, the amount and arrangement of the compartments 11 are not limited to this and can be set according to the purpose of use.

The concave structures 14 are formed at two adjacent corners on an outer side of the box 10 and are recessed on the outer surface of the box 10. The engaged shafts 15 are respectively protruded from and formed in the concave structures 14 and the two engaged shafts 15 are located coaxially. The buckle units 16 are formed on the outer side of the box 10 and can be protruding or hook-shaped. One of the buckle units 16 is close to the packaging openings 13 of the compartments 11. Other buckle units 16 are close to the retrieving openings 12 and every retrieving opening 12 corresponds to a buckle unit 16. In this embodiment, the box 10 has four buckle units 16 close to the retrieving openings 12 and two buckle units 16 close to the packaging openings 13. In another embodiment, the amount of the buckle units 16 can be set according to the purpose of use.

The retrieving covers 20 are respectively mounted on the retrieving openings 12 of the compartment 11, and the retrieving covers 20 and the retrieving openings 12 correspond one to one, that is, there are four retrieving covers 20 in this embodiment. An edge of the retrieving cover 20 connects to an edge of the compartment 11, and the other edges of the retrieving cover 20 can be selectively attached to or separated from other edges of the compartment 11. When all edges of the retrieving cover 20 are attached to the compartment 11, the retrieving cover 20 closes the compartment 10 and separates the compartment 11 from the outside of the box 10. When only one edge of the retrieving cover 20 connects to the compartment 11 and the other edges are separated from the compartment 11, the compartment 11 connects to the outside of the box 10. Each one of the retrieving covers 20 can be integrally formed with the box 10, or each one of the retrieving covers 20 can connect to the box 10 by fastening, but it is not limited thereto. Each one of the retrieving covers 20 respectively comprises a buckle slot 21, that is, the four retrieving covers 20 have four buckle slots 21 in this embodiment. When all edges of the retrieving cover 20 are attached to the compartment 11, the buckle unit 16 of the box 10 is fastened in the buckle slot 21 of the retrieving cover 20. When only one edge of the retrieving cover 20 connects to the compartment 11 and the other edges are separated from the compartment 11, the buckle unit 16 of the box 10 and the buckle slot 21 of the retrieving cover 20 are separated. In another embodiment, the position of the buckle unit 16 and the position of the buckle slot 21 are interchangeable. In other words, the buckle slot 21 can be formed at the box 10 and the buckle unit 16 can be formed at the retrieving cover 20.

The packaging cover 30 is mounted on the packaging openings 13 of the compartments 11. The packaging cover 30 comprises two protruded structures 31, two engaged holes 32, and at least one buckle slot 33. The protruded structures 31 are formed on a side of the packaging cover 30 close to the box 10 and located on two adjacent corners of the packaging cover 30. The engaged holes 32 are respectively formed on the protruded structures 31 and the two engaged holes 32 are located coaxially. The engaged shafts 15 of the box 10 are respectively mounted through the engaged holes 32. Therefore, the packaging cover 30 can rotate relative to the box 10 with the engaged shafts 15 as the axis. In another embodiment, the position of the concave structure 14 and the position of the protruded structure 31 are interchangeable, and the position of the engaged shaft 15 and the position of the engaged hole 32 are also interchangeable. In other words, the concave structure 14 can be formed at the packaging cover 30 and the protruded structure 31 can be formed at the box 10. The engaged hole 32 can be formed at the concave structure 14, and the engaged shaft 15 can be formed at the protruded structure 31.

When all edges of the packaging cover 30 are attached to the box 10, the buckle units 16 of the box 10 are fastened in the buckle slots 33 of the packaging cover 30, and the packaging cover 30 closes the compartments 10 and separates the compartments 11 from the outside of the box 10. When the packaging cover 30 rotates with the engaged shaft 15 as the axis and the edges of the packaging cover 30 are separated from the box 10, all the compartments 11 connect to the outside of the box 10. In another embodiment, one edge of the packaging cover 30 can connect to one edge of the box 10, and the packaging cover 30 can be integrally formed with the box 10, but it is not limited thereto. In addition, the position of the buckle unit 16 and the position of the buckle slot 33 are interchangeable in another embodiment. In other words, the buckle slot 33 can be formed on the box 10, and the buckle unit 16 can be formed on the packaging cover 30.

With reference to FIG. 1, when the quick-fill pill organizer is in the storage mode, all the edges of the retrieving covers 20 and all the edges of the packaging cover 30 are attached with the box 10 and separate the compartment 11 from the outside of the box 10. Therefore, the medicine or health food placed in the compartments 11 will not fall out of the box 10 or mix with the medicine or health food in other compartments 11.

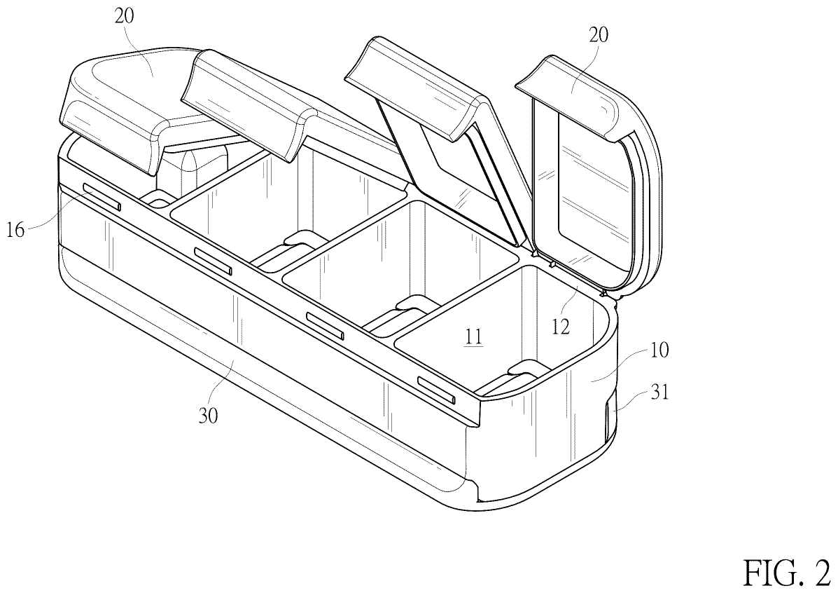

With reference to FIG. 2, when the quick-fill pill organizer is in the retrieval mode, the retrieving openings 12 of the compartments 11 are upward. At this time, the user can open the retrieving cover 20 corresponding to the specific compartment 11, and the other retrieving covers 20 can keep closing their corresponding compartments 11. Therefore, when the user takes medicine or health food, he/she only needs to open the retrieving cover 20 of one compartment 11, to prevent the medicine in the other compartments 11 from spilling or getting damp.

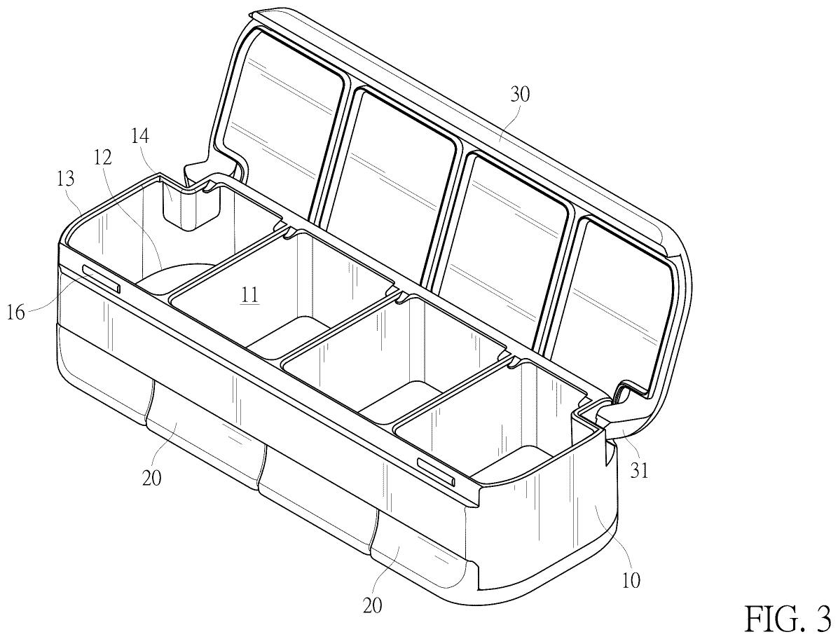

With reference to FIG. 3, when the quick-fill pill organizer is in the package mode, the packaging openings 13 of the compartments 11 are upward. At this time, after the user opens the packaging cover 30, all the compartments 11 connect to the outside of the box 10. Therefore, the user only needs to open the packaging cover 30 once to place medicines or health food in all the compartments 11. Similarly, after placing the medicine or health food, the user only needs to close the packaging cover 30 once to separate all the compartments 11 from the outside of the box 10.

The benefit of the present invention is that the compartment 11 of the quick-fill pill organizer comprises the retrieving opening 12 and the packaging opening 13. The retrieving cover 20 mounted at the retrieving opening 12 corresponds to the compartment 11 one-to-one, and the packaging cover 30 mounted at the packaging openings 13 can cover all the compartments 11 at the same time. When the user takes the medicine in the retrieval mode, he/she turns the retrieving openings 12 upward and opens the retrieving cover 20 corresponding to the specific compartment 11 to prevent the medicine in the other compartments 11 from spilling or getting damp. When the user distributes the medicine into each compartment 11 in the package mode, the packaging openings 13 are upward and the packaging cover 30 is opened. The user only needs to open or close the packaging cover 30 once to connect or close all the packaging openings 13 of the compartments 11. Therefore, the user can save a lot of time opening and closing the cover during the process of dispensing medicine.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A quick-fill pill organizer comprising:
a box comprising:
multiple compartments; the compartments mounted next to each other and each respectively comprising:
a retrieving opening; and
a packaging opening being opposite to the retrieving opening in position;
multiple retrieving covers; an amount of the retrieving covers corresponding to an amount of the compartments; each one of the retrieving covers mounted on the retrieving opening of a respective one of the compartments such that said respective one of the compartments connects to or is blocked from outside; and
a packaging cover mounted on the packaging openings of the compartments such that the compartments connect to or are blocked from outside.

2. The quick-fill pill organizer as claimed in claim 1, wherein:
the box comprises two engaged shafts formed at two adjacent corners on an outer side of the box; and
the packaging cover comprises two engaged holes; each one of the engaged shafts is respectively mounted through each one of the engaged holes; the packaging cover is rotatable relative to the box with the engaged shafts as an axis.

3. The quick-fill pill organizer as claimed in claim 2, wherein:
the box comprises two concave structures formed at the two adjacent corners on the outer side of the box; each one of the engaged shafts is formed in a respective one of the concave structures; and
the packaging cover comprises two protruded structures formed on a surface of the packaging cover and said surface is close to the box; each one of the engaged holes is formed on a respective one of the protruded structures, and each one of the protruded structures is mounted in a respective one of the concave structures.

4. The quick-fill pill organizer as claimed in claim 2, wherein the engaged shafts are mounted coaxially.

5. The quick-fill pill organizer as claimed in claim 3, wherein the engaged shafts are mounted coaxially.

6. The quick-fill pill organizer as claimed in claim 1, wherein:
the box comprises at least one buckle unit formed at an outer side of the box and close to the packaging openings; and
the packaging cover comprises at least one buckle slot formed on a surface of the packaging cover and said surface is close to the box; each one of the at least one buckle unit is configured to be fastened in a respective one of the at least one buckle slot.

7. The quick-fill pill organizer as claimed in claim 5, wherein:
the box comprises at least one buckle unit formed at an outer side of the box and close to the packaging openings; and
the packaging cover comprises at least one buckle slot formed on a surface of the packaging cover and said surface is close to the box; each one of the at least one buckle unit is configured to be fastened in a respective one of the at least one buckle slot.

8. The quick-fill pill organizer as claimed in claim 1, wherein:
the box comprises multiple buckle units formed at an outer side of the box; an amount of the buckle units corresponding to an amount of the retrieving openings; each one of the buckle units close to a respective one of the retrieving openings; and
each one of the retrieving covers comprises a buckle slot, and the buckle slot is configured to receive one of the buckle units fastened therein.

9. The quick-fill pill organizer as claimed in claim 7, wherein:
the box comprises multiple buckle units formed at an outer side of the box; an amount of the buckle units corresponding to an amount of the retrieving openings; each one of the buckle units close to a respective one of the retrieving openings; and
each one of the retrieving covers comprises a buckle slot, and the buckle slot is configured to receive one of the buckle units fastened therein.

10. The quick-fill pill organizer as claimed in claim 1, wherein an edge of each one of the retrieving covers is connected to an edge of a respective one of the compartments.

11. The quick-fill pill organizer as claimed in claim 9, wherein an edge of each one of the retrieving covers is connected to an edge of a respective one of the compartments.

12. The quick-fill pill organizer as claimed in claim 10, wherein each one of the retrieving covers is integrally formed with the box.

13. The quick-fill pill organizer as claimed in claim 11, wherein each one of the retrieving covers is integrally formed with the box.
